(19) United States
(12) Patent Application Publication
(10) Pub. No.: US 2005/0075479 A1
(43) Pub. Date: Apr. 7, 2005

(54) Process for increasing the toughness of solid state polymerized poly (trimethylene terephthalate) pellets

(76) Inventors: Robert Lawrence Blackbourn, Houston, TX (US); Houston Slade Brown, Houston, TX (US); Donald Ross Kelsey, Guerneville, CA (US); Kathleen Suzanne Kiibler, Katy, TX (US); Wen-Tzung Tang, Sugar Land, TX (US)

Correspondence Address: Donald F. Haas;Shell Oil Company, Legal - Intellectual Property, P. O. Box 2463, Houston, TX, 77252-2463, US

(21) Appl. No.: 10/957,345

(22) Filed: Oct. 1, 2004

Related U.S. Application Data
(60) Provisional application No. 60/508,661, filed on Oct. 3, 2003.

(51) Int. Cl. C08F 6/00

(52) U.S. Cl. 528/480; 264/141; 264/340

(57) ABSTRACT

This invention is a process for increasing the toughness of solid state polymerized (SSP) poly(trimethylene terephthalate) (PTT) pellets which have an intrinsic viscosity of about 0.7 dl/g or greater prior to extrusion. The process comprises extruding the PTT SSP pellets at a temperature of about 245 to about 280° C for from about 1 minute to about 20 minutes, cutting the PTT into pellets, and crystallizing the PTT pellets to about 10 to about 45 percent crystallinity.

### FIELD OF THE INVENTION

This invention relates to a process for increasing the toughness and thus reducing the friability of solid state polymerized poly(trimethylene terephthalate) (PTT) pellets.

### BACKGROUND OF THE INVENTION

PTT is a newly commercialized polyester whose properties and processes for manufacture are similar to those of the well-known and most widely used polyester, polyethylene terephthalate (PET). PTT possesses a unique combination of properties suitable for fiber and engineering plastic applications. For fiber applications, the required intrinsic viscosity (IV) of PTT is typically between 0.80 and 0.95 dl/g (equivalent to number average molecular weights of about 19,000 and 25,000 respectively). This is approximately the same number average molecular weight range for PET used in textile fiber applications. PTT for fiber applications can be advantageously produced by a combination of a melt polymerization process and a solid state polymerization (SSP) process because of the reasons given below.

Because PTT is less stable than PET and hence more susceptible to thermal degradation than PET in melt state, the melt polycondensation of PTT should be conducted at temperatures at least 20° C., preferably at least 30° C., below that for PET. Furthermore, because the major polycondensation by-product of PTT, 1,3-propanediol (PDO), is less volatile than that of PET, ethylene glycol (EG), a thin-film type polycondensation reactor, such as a disk-ring reactor, should be used to effectively remove the polycondensation by-products to achieve the IV required for fiber-grade PTT.

Consequently, a polycondensation time longer than for PET and a disk-ring type polycondensation reactor larger than for PET should be used for PTT. Furthermore, even at such lower melt polycondensation temperatures, the long residence time required to achieve the desired IV can result in inferior product properties, especially color. By terminating melt polycondensation earlier, to limit thermal degradation, and further polymerizing the melt polycondensation product in solid state at a much lower temperature to the IV suitable for the desired application, better economics and superior product quality, especially in terms of color, can be achieved. Improvements have been made in melt polymerization but the combination process is still in commercial use.

When the desired IV is reached, the melt polycondensation product is usually extruded through a strand die to produce melt strands, which are quenched with water (quenching water) to solidify them and are then chopped into pellets with a pelletizer. The PTT pellets thus obtained may be used directly for fiber spinning, if the IV is sufficiently high, or otherwise used as a prepolymer for further polymerization in the solid state.

The pelletized solid state polymerized poly(trimethylene terephthalate) (PTT) pellets are highly crystallized. This is important to prevent blocking (sticking or agglomeration) of the pellets during shipping or storage in summer months or during drying prior to spinning if the polymer is used in textile applications.

We have found that, unlike poly(ethylene terephthalate) (PET), PTT pellets produced by this conventional process employing a solid-state polymerization step become brittle or friable after undergoing crystallization and/or solid state polymerization and because of the friability of the pellets, excessive amounts of dust and fines can be generated during shipping and conveying of the crystallized solid stated PTT products. This can cause a substantial material loss and create problems in downstream operations. The most pronounced dust and fines generation occurs in high speed pneumatic conveying systems, such as a dilute phase conveying system. Material losses as high as 15 percent through dust and fines generation during conveying of solid stated PTT have been observed.

PTT pellets made by solid state polymerization also have a wide distribution of molecular weight, i.e., some pellets have an average molecular weight significantly higher or lower than the overall average (usually measured by intrinsic viscosity) and the pellets also show a wide distribution of molecular weight within the pellets themselves, having higher molecular weight near the surface of the pellets and lower molecular weight in the center. Wide variation of molecular weight distribution is disadvantageous because it can produce inhomogeneity when the PTT is processed into fibers causing spinning problems, such as breaks.

### SUMMARY OF THE INVENTION

This invention is a process for increasing the toughness of solid state polymerized (SSP) poly(trimethylene terephthalate) (PTT) pellets which, prior to extrusion, have an intrinsic viscosity of about 0.7 dl/g (as measured in 60/40 phenol/tetrachloroethane at 35° C.) or greater, preferably about 0.8 to about 0.95 dl/g. The SSP pellets may be dried prior to extrusion, if necessary, preferably to a moisture content of no more than about 50 ppm of water. The process comprises extruding the PTT SSP pellets at a temperature of about 245 to about 280° C., preferably about 250 to about 270° C., for from about 1 minute to about 20 minutes, preferably from about 1 minute to about 15 minutes, most preferably from about 1 minute to about 12 minutes, cutting the extruded PTT into pellets, and crystallizing (post-SSP crystallization) these PTT pellets to less than about 48 percent crystallinity, preferably from about 10 to about 45 percent crystallinity, more preferably from about 25 to about 45 percent crystallinity, most preferably from about 35 to about 45 percent crystallinity, by heat treatment at about 60 to about 90° C., preferably by hot water heat treatment. It is preferred that a barrier screw be used to extrude the PTT and it is also preferred that the intrinsic viscosity of the solid state polymerized PTT feed be as homogeneous as possible.

### DETAILED DESCRIPTION OF THE INVENTION

This process produces a 1,3-propanediol-based aromatic polyester, specifically poly(trimethylene terephthalate) (PTT). This refers to a polyester prepared by reacting 1,3-propanediol with at least one aromatic diacid or alkyl diester thereof. Preferably, the reactant diacid or alkyl diester is terephthalic acid (TPA) or dimethyl terephthalate (DMT).

As used herein, “1,3-propanediol-based aromatic polyester” refers to a polyester prepared by the condensation polymerization reaction of one or more diols with one or more aromatic diacids or alkyl diesters thereof (herein referred to collectively as “diacid”) in which at least 80 mole percent of the diol(s) is 1,3-propanediol. “Poly(trimethylene terephthalate)” refers to such a polyester in which at least about 80 mole percent of the diacid(s) moiety is that of terephthalic acid. Other diols which may be copolymerized in such a polyester include, for example, ethylene glycol, diethylene glycol, 1,4-cyclohexane dimethanol, bis-3-hydroxypropyl ether (dipropylene glycol) and 1,4-butanediol; and other aromatic and aliphatic acids which may be copolymerized include, for example, isophthalic acid and 2,6-naphthalene dicarboxylic acid. The poly(trimethylene terephthalate) may contain additives (such as stabilizer, toner, and dye), and delustrant, etc., added during the melt polycondensation stage to impart the desired properties. Most poly(trimethylene terephthalate) products for fiber applications can contain up to several weight percent titanium dioxide delustrant, typically about 0.05 to about 2 weight percent.

Numerous processes are known to prepare polyesters. Such processes may be batchwise or continuous and may employ one or two or multiple stages. In general, such processes have in common the reaction at elevated temperature of a diol and an aromatic diacid or dialkyl ester thereof, with the removal of byproduct water or alcohol, for a time effective to produce a polyester having an intrinsic viscosity (IV) suitable for the desired application.

In this invention, the poly(trimethylene terephthalate) polyester is prepared in a two-stage condensation polymerization process. The first stage is melt polycondensation and the second stage is solid state polycondensation. Depending on the precursors used, there are two melt polycondensation processes, namely the TPA (terephthalic acid) process and the DMT (dimethyl terephthalate) process. Each melt polycondensation process comprises two steps. While the first steps are different, the second steps are similar.

The first step of the TPA process is an esterification step wherein a molar excess of at least one diol, specifically 1,3-propanediol, is reacted with at least one diacid, specifically TPA, usually in the absence of added catalyst, at temperatures within the range of about 230 to about 270° C. under atmospheric or super-atmospheric pressure within the range of about 15 to about 80 psia. The esterification product is a mixture of oligomers of bis(3-hydroxypropyl) terephthalate (BHPT), with a degree of polymerization of about 3 to about 10, if PDO is the only diol and TPA is the only diacid used. During esterification, byproduct water is continuously removed from the reactor.

The first step of the DMT process is a transesterification step, wherein at least one diol, specifically PDO, is reacted with at least one dialkyl ester of a diacid, specifically DMT, in the presence of a suitable transesterification catalyst such as zinc acetate, magnesium acetate, or titanium alkanoate, at temperatures within the range of about 180 to about 250° C. under near atmospheric pressure. The transesterification product is also a mixture of the oligomers of BHPT if PDO is the only diol and DMT is the only diester used. The transesterification generates methanol as the byproduct which is continuously distilled off.

The second step of melt polymerization is the polycondensation step, wherein the pressure on the reaction mixture is reduced, usually in stages wherein a prepolymerization stage lowers the pressure and a polycondensation stage is carried out at constant temperature, and a polycondensation catalyst is added. The preferred polycondensation catalysts are compounds of titanium, antimony, or tin, such as titanium butoxide, present in an amount within the range of about 10 to about 400 ppm titanium, antimony, or tin, based on the weight of the polymer. The low molecular weight product of the esterification or transesterification step is heated in this polycondensation step at a temperature within the range of about 240 to about 280° C., preferably from about 245 to about 265° C., under a vacuum for a time sufficient to increase the IV of the polycondensate to at least about 0.35 dl/g (as measured in 60/40 phenol/tetrachloroethane at 35° C.) (which is equivalent to a number average molecular weight of about 4,300), preferably at least about 0.4 dl/g, most preferably at least about 0.6 dl/g, while the major byproduct of polycondensation, PDO, is removed. This step and the esterification step can be carried out in accordance with the process of U.S. Pat. No. 6,277,947, which is herein incorporated by reference.

The product of polycondensation is pelletized, using a strand pelletizer, an underwater pelletizer, or a drop-forming device, crystallized as described below, and then transferred to a solid state polymerization section in order to further polymerize the polymer to increase the intrinsic viscosity to the desired level, usually in the range of at least about 0.70, preferably about 0.80 to about 0.95 dl/g. The relatively low IV polymer produced by the melt polymerization process and intended to be further polymerized in the solid state is referred herein to as the prepolymer.

The solid state polymerization may be carried out in a similar manner as has been used for PET such as described in U.S. Pat. Nos. 4,161,578 and 5,408,035, which are herein incorporated by reference, and in “PET SSP: One of the Key Steps in PET Manufacturing,” presented in Pro Tech Forum '96, Jun. 20-21, 1996, sponsored by Buhler Limited, Uzwil, Switzerland. As described in these references, the standard continuous PET solid state polymerization process can be broken down into five steps: crystallization, drying/annealing, preheating, solid state polymerization, and product cooling. The solid state polymerization of PTT is carried out in generally the same manner.

Crystallized and preheated pellets are discharged from the crystallizer (pre-SSP crystallization) and/or preheater into the solid state reactor. Inside one preferred type of reactor, solid state polycondensation takes place as the polymer pellets move downward by gravitational force in contact with a stream of inert gas, usually nitrogen, which flows upwardly to sweep away the reaction byproducts, such as 1,3-propanediol, water, allyl alcohol, acrolein, and cyclic dimer. The nitrogen flow rate may be typically from about 0.25 to about 1.0 pound per pound of polymer and the nitrogen may be heated or unheated before entering the bottom of the reactor. The exhaust nitrogen exiting the top of the reactor may be recycled after purification. This is only one type of solid state polymerization. Other types may also be used.

The polymer pellets attain the required IV for the intended applications as they are discharged from the reactor. The solid stated product is then cooled to below about 65° C. for shipping or storage. The product may be cooled in an atmosphere of nitrogen or air.

The extrusion can be carried out using either a single screw or twin-screw extruder to provide mixing and optionally feeding to a melt pump to control the exit pressure. A barrier screw design is preferred because it can provide better mixing and a more homogeneous melt. Filtration is desirable, although not essential, and can be done using a screen-type filter or candle (or similar) filters. The extrusion is carried out at temperatures from about 245 to about 280° C., preferably about 250 to about 270° C. More than one temperature can be used, for example, with extruders with more than one heating zone. The total residence time of the melt (counting the extruder, melt pump and filter) should be from about 1 to about 20 minutes, preferably about 1 to about 15 minutes, and most preferably about 1 to about 12 minutes, depending on the temperatures used. Short residence times will minimize thermal degradation and loss of molecular weight (IV) but longer residence times will allow for better equilibration of the polymer melt and produce a polymer with a lower polydispersity (M_{w}/Mₙ). Higher temperatures increase the rate of equilibration and thermal degradation.

The solid-stated PTT feed is preferably dried to reduce the moisture content to preferably about 50 ppm or less to minimize molecular weight decrease during the extrusion. This is especially desirable if the PTT has been stored for some length of time or exposed to ambient atmosphere. In the case where the product from the solid state polymerization is subjected to the extrusion process of this invention within a relatively short time after exiting the solid state reactor and, especially if it is kept under dry atmosphere, a separate drying step before extrusion may not be necessary.

The pellets can be loaded into the extruder under air. However, a purge or blanket of nitrogen is preferred in order to minimize degradation which can increase the color.

Pre-SSP Crystallization

Pelletizing can be accomplished using underwater pelletizing which, when the water temperature is controlled to typically about 60 to about 90° C., also helps to produce pellets with the desired level of crystallinity. Alternatively, a strand pelletizer using cooled or chilled water can be used and the resulting pellets can be crystallized by hot water crystallization typically at 60 to about 90° C., preferably about 65 to about 85° C., typically for about 3 seconds to about 5 minutes, preferably about 10 seconds to about 3 minutes; or by using a mechanical crystallizer heated with hot air or hot nitrogen at a temperature of typically from about 60 to about 150° C., preferably about 90 to about 130° C., typically for about 1 minute to about 60 minutes, preferably about 1 to 30 minutes.

As described above, the pellets are generally crystallized prior to solid state polymerization. In the present process they are crystallized again after the extrusion of the solid state polymerized polymer. The crystallization of the PTT prepolymer pellets and/or the extruded solid state polymerized pellets can be carried out in the same or different manners.

Immediately after strand pelletization, the surfaces of the pellets are solid while the cores are still partially molten. To prevent the pellets from sticking together, the pellets are preferably flushed with additional cooling water, which completely solidifies the pellets and transports them to a dewatering screen to remove most of the water. The pellets made by strand pelletization at this stage are clear and have a low degree of crystallinity. A separate crystallization step is then carried out.

If underwater (hot) pelletization is used, the pellets are not cooled until after they are crystallized and by then they are opaque. In this case, some crystallization takes place during underwater pelletization and a separate crystallization step may not be necessary.

Hot water crystallization of the pellets can be carried out in a batch or continuous process. For batch processes, crystallization can be carried out in any suitable holding vessel that provides hot water agitation for adequate heat transfer and temperature control. The process is preferably carried out continuously for an efficient commercial process. Integration of crystallization into a continuous polymerization process requires coordination with upstream and downstream processing and careful control of pellet residence time in the crystallizer for uniform crystallization of the pellets. A liquid moving bed is preferred because it offers uniform residence time and uniform heating of the pellets and thus produces pellets with uniform pellet crystallization and opacity. This process is described in U.S. Pat. No. 6,297,315, which is herein incorporated by reference. For process economics, it is preferred that crystallization be carried out on the pelletization line, maximizing the use of residual pellet heat and eliminating the need for an additional pellet dryer.

Post-SSP Crystallization

In post-SSP crystallization, including either batch or continuous hot water crystallization, the poly(trimethylene terephthalate) pellets typically are immersed in hot water at temperatures within the range of about 60 to about 90° C., preferably about 65 to 85° C., for a time sufficient to achieve the desired crystallinity. The crystallinity of the extruded solid state polymerized PTT pellets is typically about 10 to about 45%, preferably about 25 to about 45%, most preferably about 35 to about 45%, to prevent the pellets from blocking. The crystallinity of the extruded PTT is usually lower than the crystallinity of the SSP polymer from which it is prepared. At crystallinity levels above about 48%, the extruded PTT pellets will show an increasing proportion of brittle pellets. Therefore, it is preferred to crystallize to less than about 48% and preferably 25% or more, most preferably 35% or more.

After the selected residence time in the crystallizer, the pellet/water slurry is discharged into a pellet dryer. The pellets are cooled to a temperature below about 60° C., either by cold water quench en route to the dryer or, if the dryer environment is sufficiently cool, in the dryer itself.

There are several options for pelletizing and post-SSP crystallization schemes. Among them are:
strand pelletization wherein the pellets are cooled and dried, followed by a separate mechanical crystallization step (i.e., thermal or hot gas) or a separate hot water treatment step
underwater pelletization followed by a separate mechanical crystallization step (i.e., thermal or hot gas) or a separate hot water treatment step
the preferred embodiment of combining pelletization and crystallization by using hot water for the pelletization.

Tests for friability (toughness) show that, before being treated by the extrusion process, a large proportion of solid-stated pellets crack or shatter when subjected to a force. However, after the extrusion process of this invention, the product exhibits almost no friable pellets.

We have also found that the molecular weight distribution in the solid state polymerization (SSP) pellets after extrusion is very different from the distribution in the pellets before extrusion. The distribution is much narrower for the extruded PTT. Typically, the SSP pellets exhibit IV's that vary by about ±0.02 to 0.04 units from pellet to pellet compared to the overall average composite IV, whereas the extruded pellets of the instant invention vary only by about ±0.01 or less. The narrower IV spread is beneficial for uniform melting during processing into fibers.

SSP pellets also exhibit higher IV at the surface than at the interior of the pellet. This molecular weight gradient can be as much as about 0.2 to about 0.4 IV units. The extruded pellets of this invention have a uniform IV throughout the pellet, so the IV range over a pellet cross section will be no more than about 0.05 IV units and typically no more than about 0.01 IV units. This aids uniform melting and producing a homogeneous melt during processing into fibers.

### EXAMPLE 1

Extrusion. PTT polymer that had been prepared by solid-state polymerization with an IV of 0.91 was dried 6 hours at 250° C. (121° C.) with heated air to a target moisture level of 30 ppm or less and conveyed to an extruder. The extruder was a CDL, single screw with a single mixing section, 70-80 rpm, 90-110 torque, and L/D=33/1 with temperature zones typically set at: #1, 510° F. (265° C.); #2: 510° F. (265° C.); #3, 510° F. (265° C.); #4, 520° F. (271° C.); #5, 520° F. (271° C.); #6, 530° F. (276° C.); #7: 530° F. (276° C.). The residence time of the melt was estimated to be about 3 minutes. The melted polymer was passed through a screen filter (44 micron/325 mesh) and die and pelletized using a Gala underwater pelletizer at a water temperature typically in the range of 62 to 78° C. The pellets were classified to remove over and undersized fractions using a SWECO classifier. No visible fines/dust were observed.

Crystallinity. The degree of (or fraction, as %) crystallinity is determined by density and calculated according to the equation
Crystallinity (%)=[(p−1.295)/(1.429−1.295)]×100
Where p is the measured density, 1.295 is the density of amorphous PTT and 1.429 is the density estimated for 100% crystallized PTT. Pellet density can be determined by methods such as gradient column, buoyancy, or low field NMR. For PTT copolymers, the density values for amorphous and 100% crystalline compositions may have to be adjusted accordingly. For the extruded polymer prepared in this example, the crystallinity was about 41% before extrusion and 12% after extrusion.

Polydispersity. The polydispersity (M_{w}/Mₙ) is measured by gel permeation chromatography (GPC) in hexafluoroisopropanol (HFIPA) using a refractive index detector. The polymer used in this example showed a polydispersity of 2.48 before extrusion and a polydispersity of 2.40 after extrusion. We expect that the polydispersity would be closer to 2.0 for extruded PTT prepared under longer extruder residence times.

Pellet-to-pellet IV distribution. The intrinsic viscosity was measured in HFIPA at 35° C. and converted to the corresponding IV in 60/40 phenol/tetrachloroethane by an established correlation. The extruded PTT and the starting SSP PTT were both classified by passing the pellets through a series of #6-#8 sieves. Pellets were taken from each fraction and the intrinsic viscosity was measured. The results are shown in Table 1 below.

TABLE 1
IV Variation for SSP and Extruded SSP PTT

| | Fraction of Total | | | | | | | |
|---|---|---|---|---|---|---|---|---|
| | 0.70% | 0% | 82.40% | 16.42% | 15.30% | 81.30% | 1.60% | 2.20% |
| | SSP | Extruded | SSP | Exruded | SSP | Extruded | SSP all | Extruded |
| | retains on | retains | retains on | retains | retains on | retains | material < | all |
| | no. 6 | on | no. 7 | on | no. 8 | on | no. 8 | material < |
| | screen | no. 6 | screen | no. 7 | screen | no. 8 | screen | no. 8 |
| | Lot 05ZZ | screen | Lot 05ZZ | screen | Lot 05ZZ | screen | Lot 05ZZ | screen |
| | 0.789 | 0 | 0.939 | 0.887 | 0.932 | 0.9 | 0.928 | 0.908 |
| | 0.871 | 0 | 0.897 | 0.886 | 0.924 | 0.899 | 0.961 | 0.909 |
| | 0.864 | 0 | 0.93 | 0.889 | 0.901 | 0.904 | 0.932 | 0.897 |
| | 0.879 | 0 | 0.895 | 0.896 | 0.926 | 0.903 | 0.894 | 0.886 |
| | 0.912 | 0 | 0.906 | 0.897 | 0.939 | 0.909 | 0.961 | 0.903 |
| | 0.871 | 0 | 0.899 | 0.894 | 0.95 | 0.896 | 1.056 | 0.908 |
| | 0.87 | 0 | 0.949 | 0.896 | 0.927 | 0.894 | 1.017 | 0.905 |
| | 0.875 | 0 | 0.902 | 0.895 | 0.928 | 0.901 | 0.917 | 0.895 |
| | 0.876 | 0 | 0.936 | 0.898 | 0.899 | 0.895 | 1.044 | 0.893 |
| | 0.895 | 0 | 0.844 | 0.897 | 0.912 | 0.9 | 0.94 | 0.896 |
| Avg | 0.870 | 0.000 | 0.910 | 0.894 | 0.924 | 0.900 | 0.965 | 0.900 |
| Std. Dev. | 0.030 | 0.000 | 0.029 | 0.004 | 0.015 | 0.004 | 0.053 | 0.007 |
| Variance | 0.0009 | 0 | 0.00084 | 0.000016 | 0.00023 | 0.000016 | 0.0028 | 0.000049 |

Notice that the SSP polymer showed pellets with IV as low as 0.789 and as high as 1.056, a total range of about 0.267 IV units. The overall average IV (taking into account the proportion of each size fraction) was 0.913 with an overall standard deviation of 0.029. The extruded material showed pellet IV's from 0.886 to 0.909, a total range of about 0.023, which is about ten times smaller range than that of the SSP polymer. The overall (weighted) average IV was 0.899 for the extruded polymer with a standard deviation of 0.005, which is about six times smaller than that of the SSP product. Both the total IV range and the standard deviation in IV show that the pellet-to-pellet variation in IV (molecular weight) is significantly narrower for the extruded polymer than for the SSP polymer.

Polymer friability. The friability (brittleness) of the polymer pellets was measured using a Ametek (Paoli, P A) Chatillon DFGS 100 Digital Force Gauge with TCM-210 Motorized Test Stand, and two flat hardened and polished metal plates. A single pellet was placed between the upper and lower horizontal plates. Pressure was applied and gradually increased (approximate motor speed of 1 mm/sec) until the pellet was either crushed or the maximum force (about 72.5 to 75 pounds; 322.5 to 333.6 newtons) was reached. The force at which the pellet crushes was read from the gauge and recorded, along with the form of breakage. Pellets were observed to crack without breaking into pieces, or to break cleanly into 2 or 3 distinct pieces, or to shatter into powder and are labeled either “C”, “B” or “S”, respectively. Pellets that remained intact after the maximum force (about 72.5 to 75 pounds; 322.5 to 333.6 newtons) had been applied are labeled “NB” (not brittle). Typically, a test sample of 10 to 20 pellets was measured. The force applied at the point where each pellet failed is recorded in Table 2.

None of the pellets of the extruded PTT broke under the test conditions. In contrast, only 20% of the SSP pellets remained unbroken. Also, 35% of the SSP pellets were cracked, 20% were broken, and 25% shattered into powder. The critical force for pellet failure in this test was generally about 67 to 72 pounds (298 to 320 newtons), but some pellets shattered under as little as about 53 to 56 pounds (236 to 249 newtons).

Under similar conditions, samples of solid-stated PET and PBT were not brittle and none of the pellets cracked or broke in this test.

TABLE 2

| SSP (N) | SSP (lbs) | Extruded |
|---|---|---|
| C - 309.0 | C - 69.50 | NB |
| C - 304.7 | C - 68.50 | NB |
| C - 314.0 | C - 70.60 | NB |
| S - 252.0 | S - 56.65 | NB |
| C - 312.3 | C - 70.20 | NB |
| NB | NB | NB |
| B - 321.2 | B - 72.20 | NB |
| NB | NB | NB |
| S - 247.3 | S - 55.60 | NB |
| NB | NB | NB |
| S - 305.6 | S - 68.70 | NB |
| C - 296.9 | C - 66.75 | NB |
| NB | NB | NB |
| B - 309.0 | B - 69.50 | NB |
| B - 304.5 | B - 68.45 | NB |
| C - 319.6 | C - 71.85 | NB |
| S - 238.6 | S - 53.65 | NB |
| C - 305.8 | C - 68.75 | NB |
| B - 299.1 | B - 67.25 | NB |
| S - 321.4 | S - 72.25 | NB |

Nomenclature key:
S - Shattered: pellet pulverized to powder
B - Broken: pellet cleanly separated into 2-3 pieces
C - Cracked: pellet remained intact but had visible fissure
NB - Not Broken: pellet essentially unchanged

### EXAMPLE 2

Film analysis. Extruded polymer prepared in a manner similar to that of Example 1 was tested by extrusion into a film using an Optical Control Systems model OCS ME20/26 film extruder/analyzer with a resolution of 100 microns operating at about 260° C. to make a film 8 cm wide and 2 mil thick. The extruded polymer showed an average of 8200 defects/m² measured on about 6 m² of film. By comparison, the SSP polymer (before extrusion) also extruded into film in this test showed about 420,000 defects/m², which defects are attributed to primarily unmelted or partially melted, inhomogeneous higher molecular weight fractions.

### EXAMPLE 3

PTT polymer prepared by solid-state polymerization with an IV of 0.92 similar to that used in Example 1 was dried and conveyed at a feed rate of 1200-1500 lbs/hr to an extruder with screw mixing section and a melt pump, 225 rpm, 90 torque, L/D=33/1 with eight temperature zones set at 240 to 260° C. (melt temperature estimated at 254-265° C.). The melted polymer was passed through a screen filter (20 micron) and die (15 holes, 0.125 inch hole diameter) and pelletized using a Gala underwater pelletizer (10 knife blades, 2800 rpm, water temperature 75-80° C.). Hot water crystallization was conducted simultaneously with pelletization with a contact time of about 1 minute. Altogether, about 22,000 lbs of PTT was processed.

The IV of the extruded PTT was typically 0.87-0.88 and crystallinity was about 39%. The slightly greater decrease in IV (0.04-0.05 units) compared to Example 1 was attributed to moisture pickup by the polymer during conveying to the extruder, sometimes reaching 190 ppm or more.

The DPG [dipropylene glycol; bis(3-hydroxypropyl) ether)] content, allyl endgroup content and PTT cyclic dimer content (all measured by NMR) of the extruded PTT did not change compared to the feed PTT under the process conditions used in this Example. Tests for friability as described above showed none of the extruded pellets prepared in this Example were broken in this test, similar to the results for Example 1.

TABLE 3

| | Solid-stated PTT | Extruded |
|---|---|---|
| | feed | PTT |
| DPG (mole %) | 2.0 | 2.0 |
| DPG (wt %) | 1.1 | 1.1 |
| Cyclic dimer (wt %) | 0.8 | 0.9 |
| Allyl endgroup (mole %) | 0.2 | 0.2 |

With regard to cyclic dimer content, the extruded PTT composition, with cyclic dimer content of about 1 weight % similar to that of the solid-stated PTT, is substantially different from all-melt PTT compositions which typically have cyclic dimer contents of 2.2-2.6 weight %. Yet, the extruded PTT has very low friability similar to all-melt PTT, which has not undergone solid-state polymerization. The low cyclic dimer content of extruded PTT prepared from solid-stated PTT using the process described herein can be an advantage during spinning and molding because PTT cyclic dimer is relatively volatile and can form deposits on the spinnerette or mold during processing.

1. A process for increasing the toughness of solid state polymerized poly(trimethylene terephthalate) pellets having, prior to extrusion, an intrinsic viscosity of at least 0.7 dl/g (as measured in 60/40 phenol/tetrachloroethane at 35° C.) which comprises extruding the solid state polymerized poly(trimethylene terephthalate) pellets at a temperature of about 245 to about 280° C. for from about 1 to about 20 minutes, cutting the extruded poly(trimethylene terephthalate) into pellets, and crystallizing the pellets to less than about 48 percent crystallinity.

2. The process of claim 1 wherein the extrusion temperature is from about 250 to about 270° C.

3. The process of claim 1 wherein the pellets are crystallized to from about 10 to about 45 percent crystallinity.

4. The process of claim 3 wherein the pellets are crystallized to from about 25 to about 45 percent crystallinity.

5. The process of claim 4 wherein the pellets are crystallized to from about 35 to about 45 percent crystallinity.

6. The process of claim 1 wherein the intrinsic viscosity of the solid state polymerized poly(trimethylene terephthalate) pellets prior to extrusion is from about 0.80 to about 0.95 dl/g.

7. The process of claim 1 wherein the extrusion is carried out for from about 1 to about 15 minutes.

8. The process of claim 7 wherein the extrusion is carried out from about 1 to about 12 minutes.

9. The process of claim 1 wherein the solid state polymerized poly(trimethylene terephthalate) pellets are dried to a moisture content of no more than 50 ppm of water prior to extrusion.

10. The process of claim 1 wherein the extrusion is carried out using a barrier screw.

11. The process of claim 1 wherein the intrinsic viscosity of the solid state polymerized poly(trimethylene terephthalate) pellets after extrusion is homogeneous such that the variation in intrinsic viscosity measured on individual pellets is no more than about 0.01 units standard deviation from the overall average intrinsic viscosity.

12. The process of claim 11 where the molecular weight gradient of the solid state polymerized poly(trimethylene terephthalate) pellets after extrusion is uniform throughout the pellets such that the variation in the intrinsic viscosity over a pellet cross section is no more than about 0.05 units.

13. The process of claim 12 where the molecular weight gradient of the solid state polymerized poly(trimethylene terephthalate) pellets after extrusion is uniform throughout the pellets such that the variation in the intrinsic viscosity over a pellet cross section is no more than about 0.01 units.

14. The process of claim 1 where the molecular weight gradient of the solid state polymerized poly(trimethylene terephthalate) pellets after extrusion is uniform throughout the pellets such that the variation in the intrinsic viscosity over a pellet cross section is no more than about 0.05 units.

15. The process of claim 14 wherein the intrinsic viscosity of the solid state polymerized poly(trimethylene terephthalate) pellets after extrusion is homogeneous such that the variation in intrinsic viscosity measured on individual pellets is no more than about 0.01 units standard deviation from the overall average intrinsic viscosity.

16. The process of claim 15 where the molecular weight gradient of the solid state polymerized poly(trimethylene terephthalate) pellets after extrusion is uniform throughout the pellets such that the variation in the intrinsic viscosity over a pellet cross section is no more than about 0.01 units.

17. The product of the process of claim 1.

18. The process of claim 1 wherein the crystallization is carried out by hot water treatment.

19. The process of claim 1 wherein a pre-solid state polymerization crystallization step is carried out before solid state polymerization.

20. The process of claim 19 in which the pelletizing and pre-solid state polymerization crystallization steps are carried out using underwater pelletization.

21. The process of claim 20 wherein the pelletizing and the pre-solid state polymerization crystallization steps are carried out at a temperature of from about 60 to about 90° C.

22. The process of claim 1 wherein the pelletizing and pre-solid state polymerization crystallization steps are carried out independently.

23. The process of claim 22 wherein the pre-solid state polymerization crystallization step is carried out by hot water crystallization.

24. The process of claim 23 wherein the hot water pre-solid state polymerizationcrystallization is carried out at a temperature of from about 60 to about 90° C.

25. The process of claim 24 wherein the hot water pre-solid state polymerizationcrystallization is carried out at a temperature of from about 65 to about 85° C.

26. The process of claim 23 wherein the hot water pre-solid state polymerizationcrystallization is carried out for from about 3 seconds to about 5 minutes.

27. The process of claim 26 wherein the hot water pre-solid state polymerizationcrystallization is carried out for from about 10 seconds to about 3 minutes.

28. The process of claim 22 wherein the pre-solid state polymerizationcrystallization step is carried out by using a mechanical crystallizer.

29. The process of claim 28 wherein the pre-solid state polymerizationcrystallization is carried out at a temperature from about 60 to about 150° C.

30. The process of claim 29 wherein the pre-solid state polymerizationcrystallization is carried out at a temperature from about 90 to about 130° C.

31. The process of claim 28 wherein the pre-solid state polymerizationcrystallization is carried out for from about 1 minute to about 60 minutes.

32. The process of claim 31 wherein the pre-solid state polymerizationcrystallization is carried out for from about 1 minute to about 30 minutes.

33. The process of claim 1 wherein the post-solid state polymerization crystallization is carried out at a temperature of from about 60 to about 90° C.

34. The process of claim 33 wherein the post-solid state polymerization crystallization is carried out at a temperature of from about 65 to about 85° C.

35. A pelletized homogeneous solid state polymerized poly(trimethylene terephthalate) which has a variation in intrinsic viscosity measured on individual pellets of no more than about 0.01 units standard deviation from the overall average intrinsic viscosity.

36. The poly(trimethylene terephthalate) of claim 35 wherein the molecular weight gradient is uniform throughout the pellets such that the variation in the intrinsic viscosity over a pellet cross section is no more than about 0.05 units.

37. The poly(trimethylene terephthalate) of claim 36 wherein the molecular weight gradient is uniform throughout the pellets such that the variation in the intrinsic viscosity over a pellet cross section is no more than about 0.01 units.

38. A pelletized homogeneous solid state polymerized poly(trimethylene terephthalate) which has a molecular weight gradient throughout the pellets such that the variation in the intrinsic viscosity over a pellet cross section is no more than about 0.05 units.

39. The poly(trimethylene terephthalate) of claim 38 which has a variation in intrinsic viscosity measured on individual pellets of no more than about 0.01 units standard deviation from the overall average intrinsic viscosity.

40. The poly(trimethylene terephthalate) of claim 39 wherein the molecular weight gradient is uniform throughout the pellets such that the variation in the intrinsic viscosity over a pellet cross section is no more than about 0.01 units.
